(19) United States
(12) Patent Application Publication
(10) Pub. No.: US 2018/0300321 A1
(43) Pub. Date: Oct. 18, 2018

(54) PROCESSING METHOD FOR AV FILE AND ESTABLISHING METHOD FOR AV FILE

(71) Applicants: ThroughTek Technology (ShenZhen) Co., Ltd., Shenzhen (CN); ThroughTek Co., Ltd., Taipei (TW)

(72) Inventor: Phokgoan Chioh, Taipei (TW)

(21) Appl. No.: 15/949,431

(22) Filed: Apr. 10, 2018

(30) Foreign Application Priority Data
Apr. 13, 2017 (TW) 106112435

(51) Int. Cl. G06F 17/30

(52) U.S. Cl. CPC G06F 17/3002; G06F 17/30088; G06F 17/30117

(57) ABSTRACT

A processing method for AV (audiovisual) file includes receiving an operation instruction corresponding to a first AV file, searching a second level unit header of the first AV file corresponding to a designated information from a second-level unit header of the first AV file, and reading a first package unit corresponding to the second-level AV information in the first AV file. Each first package unit includes an AV frame and a first-level unit header having a first-level AV information. The first-level AV information is generated according to the AV frame. The second-level unit header includes a second-level position code and a second-level AV information corresponding to the first-level unit header of each first package unit. Therefore, the package units corresponding to the operation instruction can be quickly obtained, and the processing efficiency of the AV file can be improved.

### CROSS-REFERENCE TO RELATED APPLICATION

This non-provisional application claims priority under 35 U.S.C. § 119(a) to Patent Application No. 106112435 in Taiwan, R.O.C. on Apr. 13, 2017, the entire contents of which are hereby incorporated by reference.

### BACKGROUND

### Technical Field

The instant disclosure relates to a processing method for AV (audiovisual) file, in particular, to a processing method for AV file and an establishing method for AV file, where the AV frame(s) in the AV file can be searched, divided, combined, or recorded in a quick manner.

### Related Art

Several AV (audiovisual) file package formats are available to the users, such as, for example, MP4 and AVI. These file package formats allow the AV file to have fine and lifelike qualities so as to enable the users to enjoy high quality entertainments.

However, in the common AV formats like MP4 or AVI, important information is stored in the beginning or ending of the AV file. In this case, when the AV file is to be searched, combined, or divided, the contents of the whole AV file have to be parsed again. The parsing procedure may not only waste resources but also increase the possibility to damage the file. In an alternative manner, the user has to do some searches within the AV file manually; namely, the user has to search the target fragments by an approach of forwarding the AV file. As a result, the processing of the AV file is inefficient.

### SUMMARY

In view of these problems, a processing method for audiovisual (AV) file and an establishing method for AV file are provided. Accordingly, certain package unit (AV frame) can be found quickly, thereby the processing efficiency of the AV file can be improved.

In one embodiment, a processing method for AV file comprise receiving an operation instruction corresponding to a first AV file, searching a second-level AV information corresponding to a designated information from a second-level unit header of the first AV file, regarding a first-level position code of the second-level AV information as a designated position code, and reading, by a reading unit, a first package unit whose first-level position code is the designated position code according to the designated position code. Specifically, the first AV file comprises the second-level unit header and a plurality of first package units. Each of the first package units comprises an AV frame and a first-level unit header. Each of the first-level unit headers has a first-level AV information and a first-level position code of the first package unit. The first-level AV information is generated according to the AV frame. The second-level unit header comprises a second-level position code and the second-level AV information corresponding to each of the first package units. Each of the second-level AV information records at least one part of the first-level AV information of the corresponding first package unit and the first-level position code of the corresponding first package unit.

In one embodiment, an establishing method for AV file comprises receiving at least one AV frame, recording the at least one AV frame as at least one first package unit, and packaging the at least one first package unit as at least one second package unit. The recording step of each of the first package units comprises generating a first-level unit header according to the at least one AV frame and combining the at least one AV frame and the first-level unit header to be the first package unit. Specifically, the first-level unit header stores a first-level AV information and a first-level position code of the at least one first package unit which correspond to the at least one AV frame. Each of the at least one second-level package units comprises a second-level unit header and a predefined number of the first package units, and the second-level unit header records the first-level AV information and the first-level position code of each of the corresponding first package units and a second-level position code.

As above, since the unit headers record the AV information of the corresponding package units, by searching the AV information of the unit headers, the corresponding package units can be obtained and corresponding AV frames can be obtained. Hence, the processing of the AV file becomes more efficient.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic view of an electronic device of a first embodiment of the instant disclosure;

FIG. 2 illustrates a schematic view of an audiovisual (AV) file of the first embodiment;

FIG. 2A illustrates a schematic view of a second-level unit header of the instant disclosure;

FIG. 3 illustrates a flowchart of a processing method for AV file of the first embodiment;

FIG. 4 illustrates a schematic view of one embodiment of a package unit;

FIG. 5 illustrates a schematic view of another embodiment of the package unit;

FIG. 6 illustrates a flowchart of a processing method for AV file of a second embodiment of the instant disclosure;

FIG. 7 illustrates a flowchart of a processing method for AV file of a third embodiment of the instant disclosure;

FIG. 8 illustrates a flowchart of one embodiment of an establishing method for AV file of the instant disclosure;

FIG. 9 illustrates another flowchart of one embodiment of the establishing method for AV file; and

FIG. 10 illustrates a flowchart of another embodiment of the establishing method for AV file.

### DETAILED DESCRIPTION

In some embodiments, the processing method for audiovisual (hereinafter abbreviated as AV) file according to the instant disclosure may be implemented by a computer program product, and the computer program product comprises at least one program instruction. Therefore, after an electronic device loads and executes the program instruction, the processing method for AV file can be achieved. Similarly, the establishing method for AV file according to the instant disclosure may be implemented by a computer program product, and the computer program product comprises at least one program instruction. Therefore, after an electronic device loads and executes the program instruction, the establishing method for AV file can be achieved. In some embodiments, the computer program product is a computer readable medium, and the program instruction is stored in the computer readable medium for the electronic device to read and load. In some embodiments, the program instruction itself may be the computer program product, and the program instruction is transmitted to the electronic device wiredly or wirelessly.

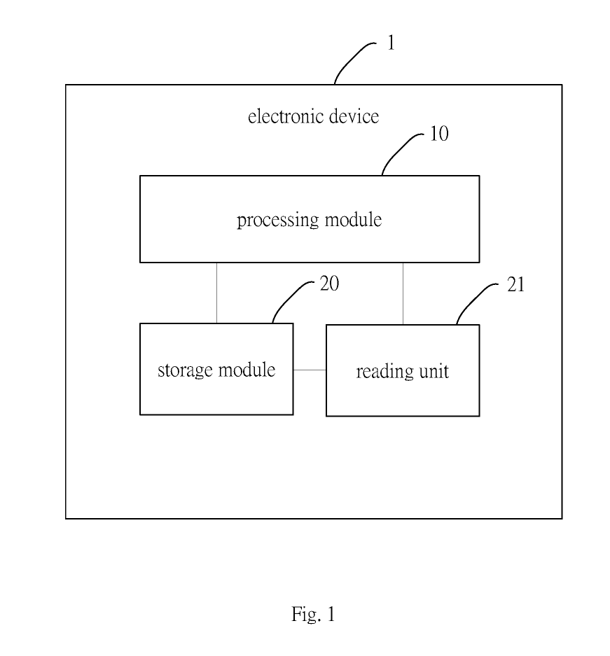

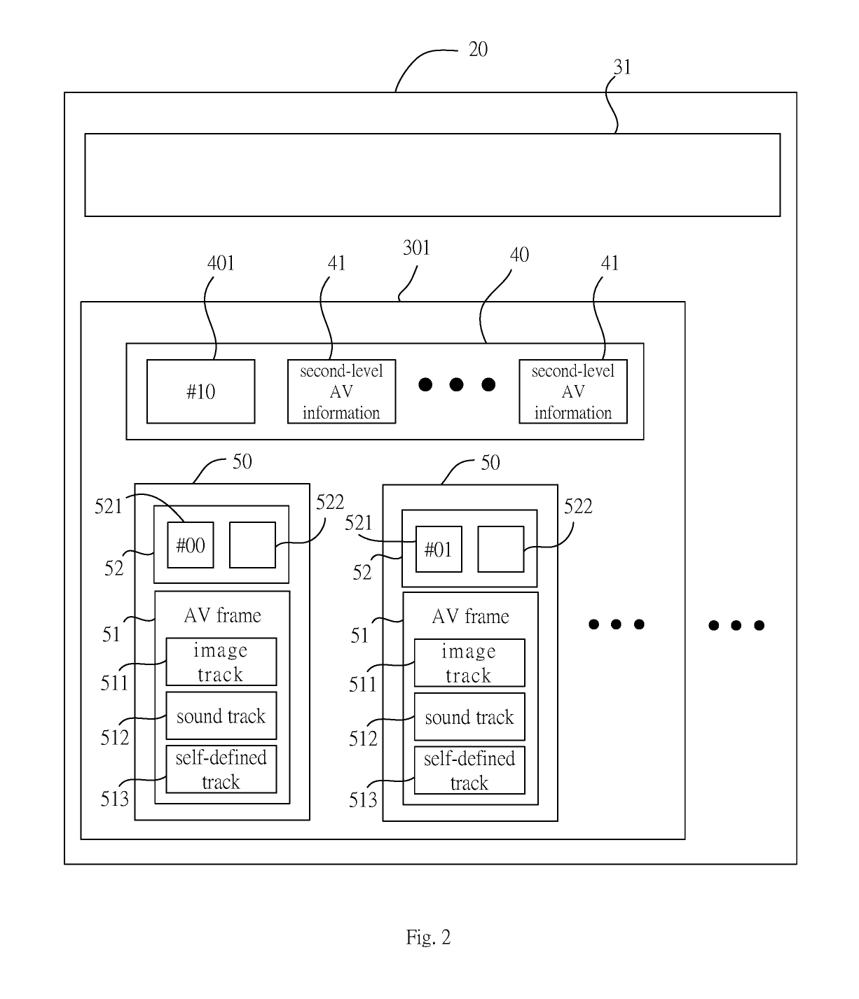

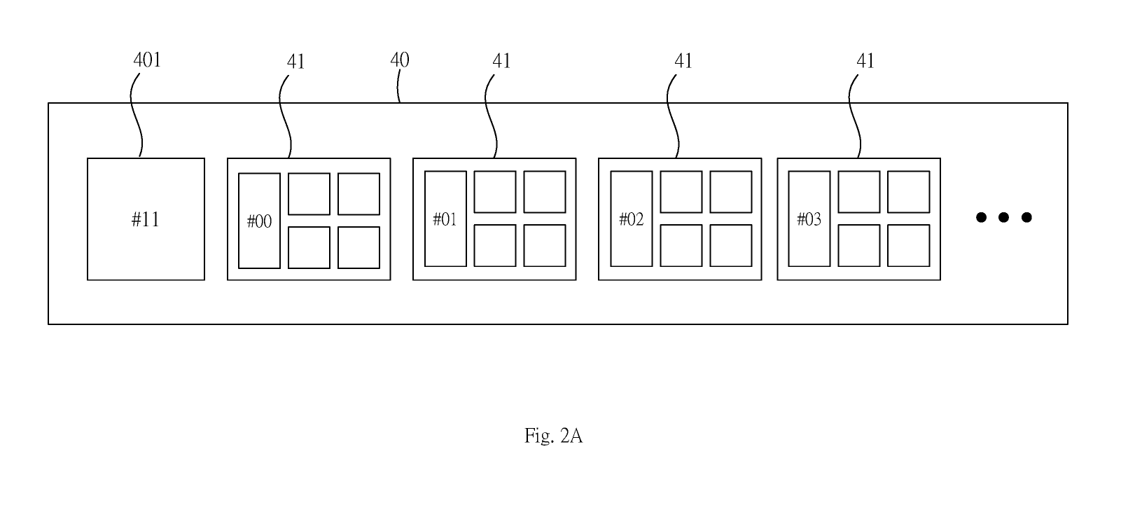

FIG. 1 illustrates a schematic view of an electronic device of a first embodiment of the instant disclosure. FIG. 2 illustrates a schematic view of an AV file of the first embodiment. FIG. 2A illustrates a schematic view of a second-level unit header of the instant disclosure. Please refer to FIGS. 1, 2, and 2A. The electronic device 1 comprises a processing module 10, a storage module 20, and a reading unit 21. The processing module 10 is respectively connected to the storage module 20 and the reading unit 21. The storage module 20 stores an AV file 30. The AV file 30 comprises a second-level unit header 40 and a plurality of first package units 50. Further, the second-level unit header 40 comprises at least one second-level AV information 41 and a second-level position code 401.

Each of the first package units 50 comprises an AV frame 51 and a first-level unit header 52. The AV frame 51 comprises an image track 511 and a sound track 512. The first-level unit header 52 stores a first-level position code 521 (hereinafter called position code) and a first-level AV information 522. The first-level position code 521 corresponds to the first package unit 50. The first-level AV information 522 corresponds to the AV information of the first package unit 50, so that the reading unit 21 can read corresponding elements quickly. In other words, the first-level AV information 522 of the first-level unit header 52 corresponds to the image track 511 and the sound track 512 of the AV frame 51.

In some embodiments, the first-level AV information 522 may comprise unit size, timestamp, encoding type, playing speed (e.g., FPS), basic data for image, basic data for sound, and position records of elements.

The position code indicates the level of the first package unit 50 and the serial number of the first package unit 50. In some embodiments, the position code may be binary, octal, decimal, hexadecimal, etc.

The unit size indicates the total bytes of the first package unit 50 from the beginning (including the first-level unit header 52) to the ending.

The timestamp indicates the time the package unit is captured. In some embodiments, the timestamp may be a value of the time difference between the captured time and a default time (e.g., 00 hour, 00 minute, and 0.000 second (at midnight) at the event day), and the unit of timestamp is milliseconds. For example, in the case that the captured time of the package unit is 9 o'clock, the package unit is captured 324000 seconds later after the default time (e.g., 0:00). Therefore, the value of the time difference is 32400000 milliseconds. In the case that the time difference is recorded in hexadecimal, the timestamp representing the time difference being 32400000 is 0x01EE6280.

The encoding type comprises an image encoding type and a sound encoding type. In one embodiment, the image encoding type and the sound encoding type may be represented by four digits of Latin scripts and four digits of numbers. In other words, the image coding type and the sound coding type respectively take four bytes, but embodiments are not limited.

The playing speed indicates the frames to be recorded in each second, that is, the frame per second of the AV file 30. Hence, when the AV file 30 is to be played, the player can play the AV file with a proper playing speed.

The basic data for image comprises the video dimension of each frame, such as, length and width, resolution, etc. The embodiments are not limited thereto.

The basic data for sound comprises the audio dimension of the sound, such as sampling frequency, bit depth, and number of channels.

Each element in the first package unit 50, such as the image track 511 and the sound track 512, corresponds to a position record. In other words, the position record indicates a byte position difference between the offset of the corresponding element and the offset of the whole first package unit 50. For example, the offsets of the image track 511, the sound track 512, and a self-defined track 513 are respectively have four bytes for recording the beginning positions of the image track 511, the sound track 512, and the self-defined track 513, respectively. The position is represented by the byte position difference (i.e., the displacement) between the offset of the track and the offset of the first-level unit header 52.

In some embodiments, the AV information may further comprise a frame type to record specific image compression format (e.g., H264). In some embodiments, the frame type may be I (intra pictures), P (predicted pictures), or B (bi-directional pictures).

The image track 511 and the sound track 512 have original data of the AV. In other words, each of the first package units 50 records one AV frame 51. The AV frame 51 comprises a frame image and one or more sound data packs The image track 511 of the first package unit 50 has the frame image, and the sound track 512 of the first package unit 50 has all of the sound data packs of the AV frame 51. In some embodiments, the AV file 30 may be divided into a plurality of consecutive AV fragments according to a predefined frame number, and each of the AV fragments is formed by collecting several consecutive first package units 50.

In some embodiments, each of the first package units 50 may further comprise a self-defined track 513, and the self-defined track 513 stores user-defined data. In this case, the AV information of the first-level unit header 52 further has the position record of the self-defined track 513.

In some embodiments, the self-defined track 513 may record the tag information of the AV frame in a binary structure and a plain text form. For example, the self-defined track 513 may record date: 2015 Jun. 1, time: 16:00:00, location: New York station, weather: mist, camera number: 35, event type: crossing warning-line, event level: warning, suspect: Andy, gender: male, or the self-defined track 513 may record other tag information related to the AV frame.

In this embodiment, for example, at the very moment of 9 o'clock, Jan. 1, 2016, an event concerning of invading warning region is detected in the image captured by the #35 camera, and the system may store the event in the self-defined track 513 along with the corresponding AV frames 51. In this embodiment, the self-defined track 513 may store the date, the time, the event type, and the warning level, etc. In some embodiments, the self-defined track 513 may further store other detected useful information, such as camera number, position coordinate of the event on the frame, the gender of the person who causes the event.

The data recorded by the self-defined track 513, similar to the first-level unit header 52 or the second-level unit header 40, is provided as a key-value. Therefore, the self-defined track 513 may be adapted to store tree data structure. Furthermore, the contents of the self-defined track 513 may be defined by the user. Hence, the self-defined track 513 may be regarded as a NoSQL database, but embodiments are not limited thereto.

Please refer to FIGS. 2 and 2A. The second-level AV information 41 of the second-level unit header 40 extracts information of the corresponding first-level unit header 52. Namely, the second-level unit header 40 extracts information of the first-level position code 521 and the first-level AV information 522 of the first-level unit header 52 of the corresponding first package unit 50. In other words, each of the second-level AV information 41 of the second-level unit header 40 records all of the information in the first-level unit header 52 of the corresponding first package unit 50. For example, in the case that the first-level position code 521 of the first package unit 50 is #01, the corresponding second-level AV information 41 of the second-level unit header 40 stores the information of the first package unit 50 having the #01 first-level position code 521, and the corresponding second-level AV information 41 also extracts the AV information of the AV frame 51 of the corresponding first package unit 50, and the AV information includes timestamp, encoding type, playing speed (e.g., FPS), basic data for image, basic data for sound, and position records of elements.

In other words, an N+1th-level unit header has an N+1th-level position code and a plurality of N+1th-level AV information, and each of the plurality of N+1th-level information corresponds to one of Nth package units. Further, an Nth-level unit header of the Nth package unit further has an Nth-level position code and a plurality of Nth-level AV information, and the Nth-level position code and the Nth-level AV information are respectively extracted in the N+1th-level AV information of the N+1th-level unit header corresponding to the Nth package unit.

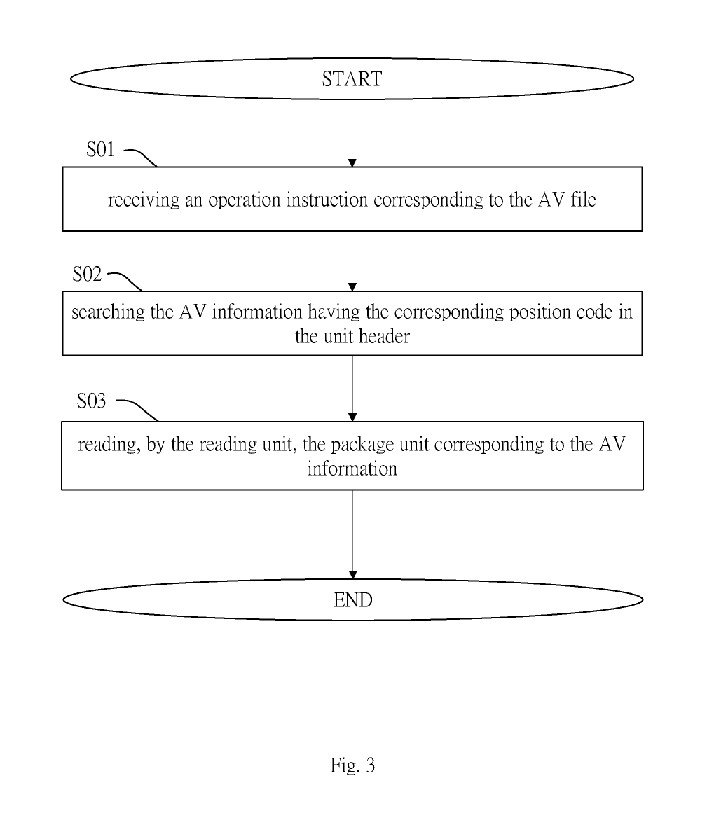

FIG. 3 illustrates a flowchart of a processing method for AV file of the first embodiment. Please refer to FIGS. 1 to 3, by searching the 73^{rd} AV frame as an example, the processing module 10 of the electronic device 1 receives an operation instruction corresponding to the AV file 30 (i.e., the searching instruction, such as searching a certain warning event, and the searching instruction comprises designated information, e.g., the 73^{rd} AV frame) (step S01). The AV file 30 has a third package unit, and the third package unit has a third-level unit header 31 and a plurality of second package units 301. Each of the second package units 301 has a second-level unit header 40 and a plurality of first package units 50. The processing module 10 searches the third-level unit header 31 of the third package unit in the AV file 30 according to the searching instruction and obtains the third-level AV information having the #17 position code in the third-level unit header 31. Then, the processing module 10 further searches the second-level AV information 41 having the #17 position code (i.e., the #17 second-level position code 401) in the corresponding second-level unit header 40 according to the third-level AV information (step S02). Next, the processing module 10 drives the reading unit 21 to read the first package unit 50 corresponding to the second-level AV information 41 (step S03). The steps S01 to S03 are repeated, and the reading unit 21 is adapted to obtain the #2 position code (i.e., the #02 first-level position code 521) from the first-level unit header 52 of the first package unit 50 having the #17 position code. Hence, the reading unit 21 can further read the first-level AV information 522 having the #02 position code in the first-level unit header 52. Accordingly, the searching of the AV frame 51 recorded by the 73^{rd} first package unit 50 can be achieved. Similarly, when several consecutive AV frames 51 are searched, the first package unit 50 of the first-level position code 521 of the first AV frame 51 and the first package unit 50 of the first-level position code 521 of the last AV frame 51 are searched from the consecutive AV frames 51 in similar manners, and details are omitted.

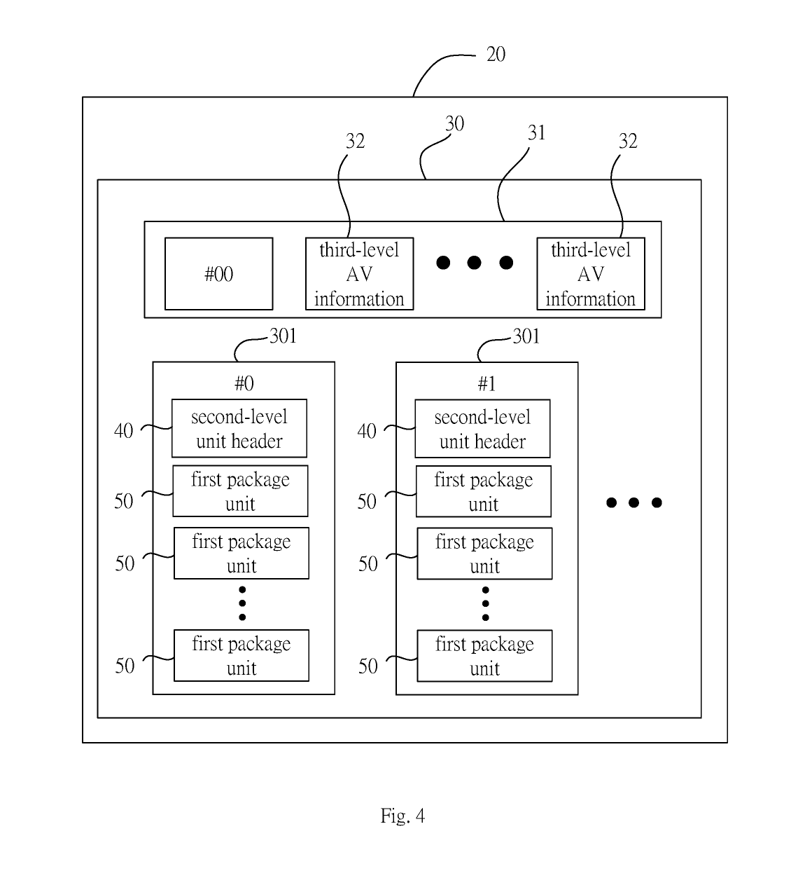

FIG. 4 illustrates a schematic view of one embodiment of the package unit. Please refer to FIGS. 2 and 4. In some other embodiments, a predefined number of first package units 50 and the second-level unit header 40 may be collected to be a second package unit 301, and the second-level unit header 40 is related to the first-level unit headers 52 of all of the first package units 50 in the second package unit 301. In other words, the first package unit 50 is a basic package unit (i.e., a zero-level package unit), the first-level unit header 52 in the first (basic) package unit 50 is a basic unit header, and the second package unit 301 is a first-level package unit. In some embodiments, when the number of the first package unit 50 exceeds the predefined number, the AV file 30 comprises several second package units 301.

Similarly, a predefined number of second package units 301 and a unit header (i.e., a third-level unit header 31) may be further collected to be a third package unit (i.e., a second-level package unit), and the third-level unit header 31 is related to the second-level unit headers 40 of all of the second package units 301 and the first-level unit headers 52 of all of the first package units 50 in the third package unit. Further, the third package unit may generate a corresponding position code (i.e., a third-level position code).

As an example, the predefined number is taken as ten (but embodiments are not limited thereto), every ten first package units 50 are collected to be one second package unit 301 (i.e., ten units), every ten second package units 301 are collected to be one third package unit (i.e., hundred units), every ten third package units are collected to be one fourth package unit (i.e., thousand units), and so forth. Hence, the AV file 30 with package units in a multi-hierarchical manner can be formed. In other words, the AV file 30 has a hierarchical affine package structure, and the package units have affine structures and are stacked in a hierarchical manner.

An upper-level unit header (e.g., the second-level unit header 40 or the third-level unit header 31) has the AV information (e.g., the first-level AV information or the second-level AV information 41) and the position codes (e.g., the first-level position codes or the second-level position codes) of all of lower-level package units (e.g., the first (basic) package units 50 or the second package units 301) owned by the belonging upper-level package unit (e.g., the second package unit 301 or the third package unit). The AV information comprises unit size, timestamp, encoding type, playing speed (e.g., FPS), basic data for image, basic data for sound, and position records of elements (lower-level package units). In this case, the lower-level package unit corresponds to a position record, and the position record may represent a byte position difference between the offset of the corresponding element and the offset of the whole upper-level package unit.

In some embodiments, in the hexadecimal case, the position code of the unit header (e.g., the first-level unit header 52, the second-level unit header 40, or the third-level unit header 31) may be represented by one byte. Former four bits represent the level of the package unit, e.g., 0 indicates basic package unit, 1 indicates first-level package unit (ten units), 2 indicates second-level package unit (hundred units), and so forth. Latter four bits represent the serial number of the package unit. For example, if the position code of the unit header is 29, the package unit is a #9 second-level package unit (hundred units).

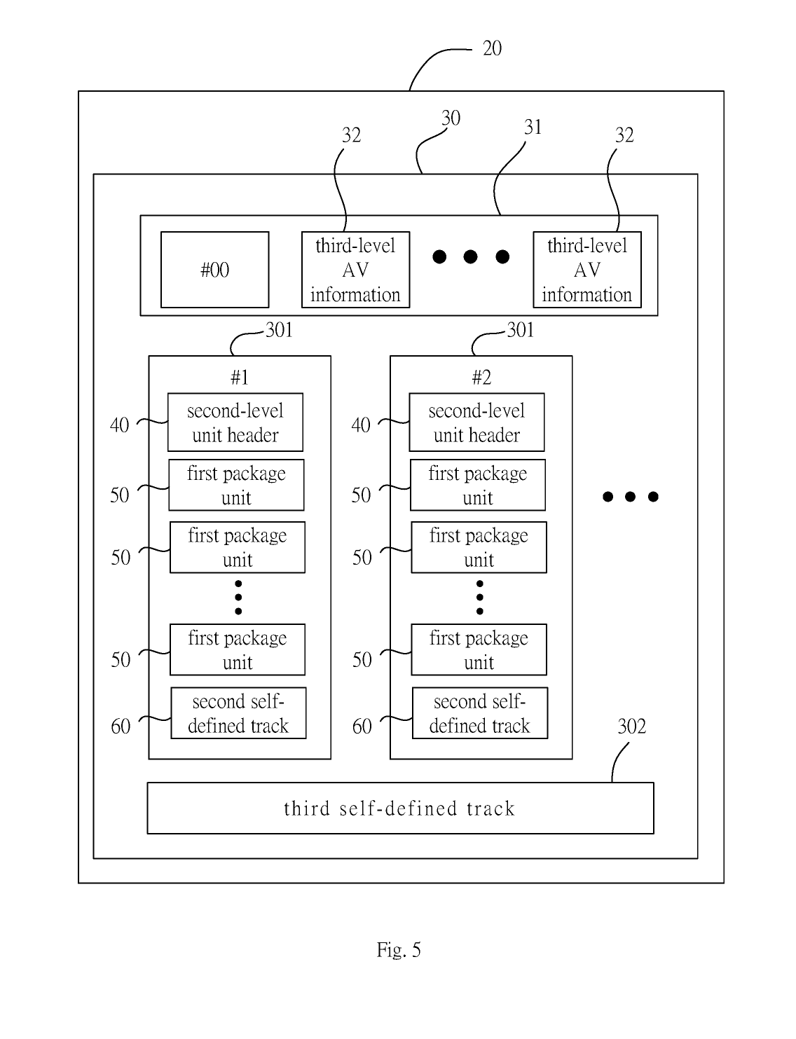

FIG. 5 illustrates a schematic view of another embodiment of the package unit. Please refer to FIGS. 2 and 5. In some embodiments, in the case that the first (basic) package unit 50 comprises the self-defined track 513, the upper-level package unit (e.g., the second package unit 301 or the third package unit) having the basic package unit 50 may further comprise an upper-level self-defined track (e.g., a second self-defined track 60 or a third self-defined track 302). Furthermore, the upper-level self-defined track may comprise all of, extracts of, or sum of the self-defined data of the self-defined tracks 513 of all of the basic package units 50 owned by the belonging upper-level package unit.

In one embodiment, when the AV file 30 comprises the third-level unit header 31 and the second package unit 301, the information in the self-defined track 513 of the first package unit 50 would be simplified to be stored in the third-level AV information 32 of the third-level unit header 31. For example, the third-level AV information 32 of the third-level unit header 31 may record the event level: 01: warning, 03: warning, 07: suspected, or may record the event type: 01: crossing warning-line, 03: crossing warning-line, 07: unknown identity, etc. Accordingly, by the manner of event index, it is understood that, in numbers 1 and 3 (i.e., the aforementioned 01, 03), warning states are recorded; while in number 7 (i.e., the aforementioned 07), an event with unknown identity is detected, and so forth.

In this embodiment, when the processing module 10 receives the searching instruction to search the AV frame 51 corresponding the #273 position code (i.e., the designated information), the processing module 10 drives the reading unit 21 to read the second package unit 301 corresponding to the third-level AV information having the #22 position code in the third-level unit header 31. Then, the processing module 10 drives the reading unit 21 to read the position of the first package unit 50 corresponding to the second-level AV information having the #17 position code in the second-level unit header 40 of the second package unit 301. Next, the processing module 10 drives the reading unit 21 to read the first package unit 50 corresponding to the first-level AV information 522 having the #2 position code. Therefore, the first-level unit header 52, the image track 511, the sound track 512, or the self-defined track 513 corresponding to the AV frame 51 having the #273 position code can be searched, so that AV information data can be obtained from the first-level unit header 52, image data can be obtained from the image track 511, sound data can be obtained from the sound track 512, and/or self-defined data can be obtained from the self-defined track 513. Accordingly, the AV frame 51 corresponding to the #273 position code can be searched quickly.

In this embodiment, when the electronic device 1 receives the searching instruction for searching the AV frames 51 in certain fragments of the AV file 30, the processing module 10 can directly read and record the first package units 50 of the AV frames 51 in the second-level AV information 41 via the position code of second-level unit header 40. Namely, the processing module 10 can read the AV information data from the corresponding first-level unit header 52, the image data from the corresponding image track 511, the sound data from the corresponding sound track 512, and/or self-defined data from the corresponding self-defined track 513. Accordingly, the searching time can be reduced.

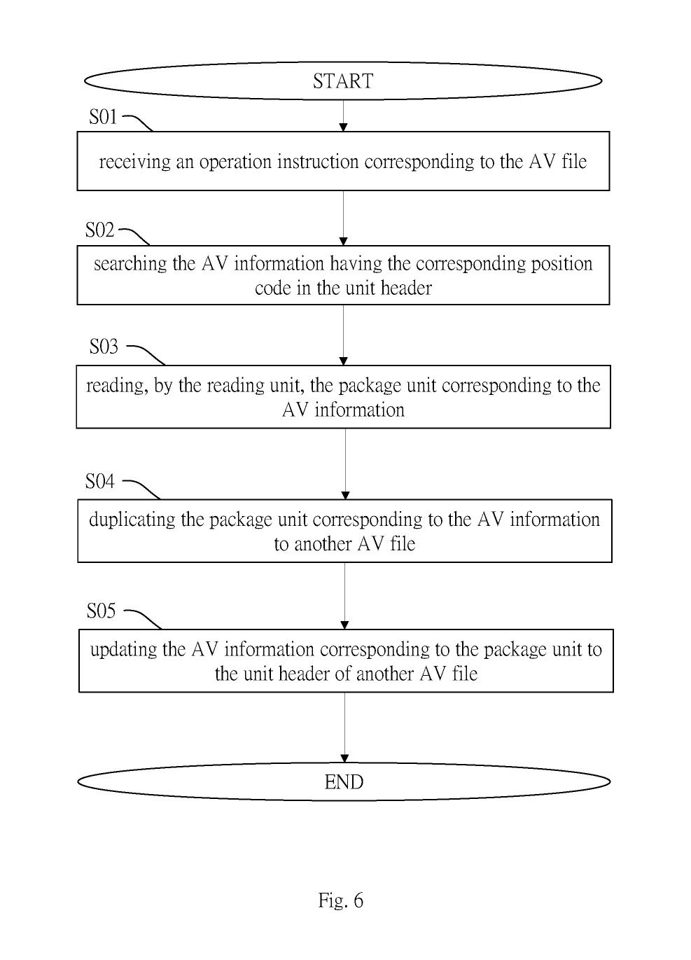

FIG. 6 illustrates a flowchart of a processing method for AV file of a second embodiment of the instant disclosure. In the second embodiment, as an illustrative example, two AV files are combined with each other (hereinafter called, the first AV file and the second AV file). In this embodiment, the first AV file and the second AV file have the same file format (i.e., the hierarchical affine package structure). The first AV file comprises AV frames from #000 to #272, and the second AV file comprises AV frames from #273 to #999. In other words, the first AV file comprises one fourth-level unit header and three third package units, and the second AV file comprises one fourth-level unit header and eight third package units. Each of the third package units (i.e., each of the third package units in the first AV file and in the second AV file) comprises one third-level unit header 31 and ten second package units 301, and each of the second package units 301 comprises one second-level unit header 40 and ten first package units 50.

Please refer to FIGS. 2, 4, and 6. The processing module 10 of the electronic device 1 firstly receives an operation instruction corresponding to the first AV file and the second AV file (i.e., a combining instruction, and the combining instruction comprises designated information, e.g., the designated information is the 272^{nd} AV frame of the first AV file and the 273^{rd} AV frame of the second AV file) (step S01). The processing module 10 searches the fourth-level unit header of the first AV file and the four-level unit header of the second AV file according to the combining instruction, so that the processing module 10 can search the four-level AV information having the #22 position codes in the two AV files, respectively (step S02). Then, the reading unit 21 is utilized to read the third package units corresponding to the position codes of the fourth-level AV information in the two AV files, respectively (step S03).

Next, the processing module 10 further searches the third-level AV information of the third-level unit header 31 having the #22 position code in each of the third package units according to the combining instruction, so that the processing module 10 can obtain the second-level AV information 41 having the #17 position code in the third-level AV information. The reading unit 21 reads, in the third package unit, the second package unit 301 corresponding to the second-level AV information 41. Namely, The reading unit 21 reads the second package unit 301 corresponding to the second-level AV information 41 having the #17 position code in the third-level unit header of the third package unit having the #22 position code (that is, the steps S01 to S03 are executed repeatedly).

Next, the processing module 10 duplicates all of the first package units 50 of the second package unit 301 of the third-level AV information having the #17 position code of the third package unit of the fourth-level AV information having the #22 position code in the first AV file to the second package unit 301 of the third-level AV information having the #17 position code of the third package unit of the fourth-level AV information having the #22 position code in the second AV file (that is, the processing module 10 duplicates the first-level unit header 52, the image track 511, the sound track 512, or the self-defined track 513 of each of the first package units 50 corresponding to the second-level AV information 41 of the second package unit 301 having the #17 position code of the third package unit having the #22 position code in the first AV file obtained in the step S03 to positions with the same position codes in the second AV file) (step S04). Then, the first-level AV information 522 of the first-level unit header 52 of the second package unit 301 having the #17 position code of the third package unit having the #22 position code in the first AV file is updated to the first-level unit header 52 of the second package unit 301 having the #17 position code of the third package unit having the #22 position code in the second AV file (step SO5). That is, the AV information of the first-level unit header 52 of the second package unit 301 having the #17 position code of the third package unit having the #22 position code in the first file is integrated with the AV information of the first-level unit header 52 of the second package unit 301 having the #17 position code of the third package unit having the #22 position code in the second file.

Similarly, the steps S04 and S05 are repeated, and the second package units 301 having the #0 to #16 position codes of the third package unit having the #22 position code in the first AV file is combined to positions with the same position codes in the second AV file, and the third package units having the #20 to #21 position codes in the first AV file is combined to positions having the #20 to #21 position codes in the second AV file.

In other words, the second AV file also has a unit header and several package units corresponding to the unit header. When one package unit corresponding to the AV information in the first AV file is duplicated to the second AV file, the package unit becomes one of the package units of the second AV file. Then, the position codes and the AV information of the unit header of the first AV file duplicated to the second AV file are updated to the corresponding unit header of the second AV file. Therefore, the first AV file and the second AV file can be combined with each other, and a first AV file having AV frames from #000 to #999 can be obtained.

In this embodiment, a first AV file having a former AV frame is duplicated to a second AV file having a latter AV frame. Alternatively, a second AV file having a latter AV frame may be duplicated to a first AV file having a former AV frame.

In some embodiments, the first AV file and the second AV file are aligned and combined with each other according to the timestamp order. Furthermore, the first AV file and the second AV file may be combined with each other according to the order of the position codes. In other words, when a first AV file with the #27 position code is combined with a second AV file with the #28 position code, the first AV file is located before the second AV file. Namely, the AV frames can be combined with each other in an order in accordance with user requirements, but embodiments are not limited thereto.

In one embodiment, two AV files are combined with each other. In some embodiments, a single AV frame in a first AV file may be combined with the second AV file, or an AV fragment including several AV frames in the first AV file may be combined with the second AV file.

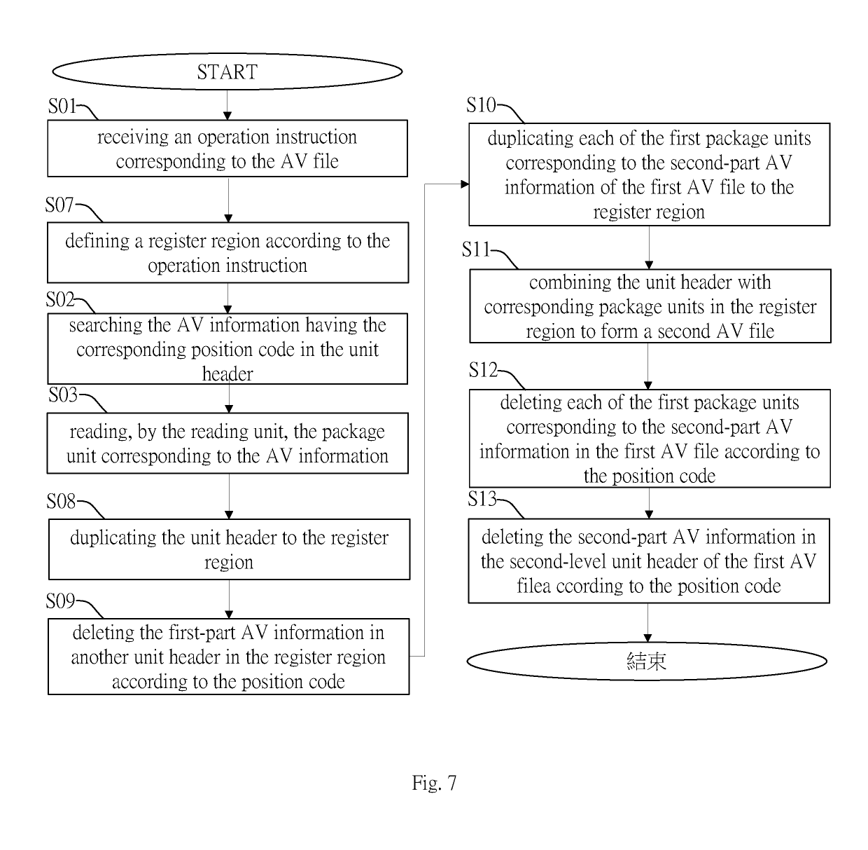

FIG. 7 illustrates a flowchart of a processing method for AV file of a third embodiment of the instant disclosure. In the third embodiment, as an example, a first AV file having AV frames from #000 to #999 is divided into a first AV file having AV frames from #000 to #272 and a second AV file having AV frames from #273 to #999. In this embodiment, the first AV file and the second AV file have the same file format of the aforementioned AV file 30. In other words, the first AV file comprises one fourth-level unit header and eight third package units, each of the third package units comprises one third-level unit header 31 and ten second package units 301, and each of the second package units 301 comprises one second-level unit header 40 and ten first package units 50.

Please refer to FIGS. 2, 4, and 7. When the processing module 10 of the electronic device 1 receives an operation instruction corresponding to the AV file (i.e., a dividing instruction) (step S01), the AV information in the first AV file can be divided into a first-part AV information and a second-part AV information according to the designated information. Next, the processing module 10 defines a register region in the storage module 20 according to the dividing instruction (step S07). Then, the processing module 10 searches the fourth-level unit header of the first AV file according to the dividing instruction, so that the processing module 10 can obtain the fourth-level AV information having the #22 position code of the fourth-level unit header in the first AV file (step S02), and the reading unit 21 reads the third package unit corresponding to the fourth-level AV information (step S03).

Then, the processing module 10 duplicates all of the second package units 301 of the third package units corresponding to the fourth-level AV information having the #22 position code in the first AV file and the unit headers of the first package units 50 of each of the second package units 301 (i.e., the third-level unit header 31, the second-level unit headers 40, and the first-level unit headers 52) to the register region (step S08). Next, the processing module 10 deletes the third-level AV information 32 in the third-level unit headers 31 of all of the second package units 301 after the 18^{th} second package unit in the corresponding third package unit of the fourth-level AV information having the #22 position code in the register region according to the position codes (step S09). Then, the processing module 10 deletes the AV information of the second-level unit headers 40 of all of the #0 to#16 second package units 301 of the third package unit having the #22 position code in the register region according to the #22 position code.

And, based on the steps of S02 to S10, the processing module 10 searches the first-level unit header 52 of the first package unit 50 having the #2 position code in the second package unit 301 having the #17 position code in the 22^{nd} third package unit, the processing module 10 reads all of the data of the first-level unit header 52 of the first package unit 50 having the #2 position code, and the processing module 10 duplicates such data to the first-level unit header 52 of the first package unit 50 having the #2 position code corresponding to the #17 position code in the register region (step S10). Next, the processing module 10 deletes all of the data of the AV information of the first-level unit headers 52 after the first package unit 50 having the #3 position code in the first AV file accordingly, and the processing module 10 deletes all of the data of the AV information of the first-level unit headers 52 of the first package units 50 having the #0 to #1 position codes in the register region. Next, the processing module 10 combines the second-level unit header 40 and the first package units 50 in the register region with each other to form the second AV file (step S11).

Further, the processing module 10 deletes each of the first package units corresponding to the second-part AV information in the first AV file (step S12). In other words, the processing module 10 deletes all of the data of the first package units 50 having the #0 to #2 position codes of the second package unit 301 corresponding to the second-part AV information having the #17 position code in the first AV file. Next, the processing module 10 deletes the corresponding second-part AV information of the second-level unit header in the first AV file (step S13).

Accordingly, a first AV file having AV frames from #000 to #999 can be divided into a first AV file having AV frames from #000 to #272 and a second AV file having AV frames from #273 to #999.

In some embodiments, the AV file is divided into two AV files, but embodiments are not limited thereto. In some other embodiments, the AV file may be divided into three or more AV files. In the following embodiment, the AV file is divided into three AV files. Please refer to FIGS. 2, 4, and 7. In the step S07, the processing module 10 defines a register region in the storage module 20 according to the dividing instruction, and the register region comprises a first register region and a second register region. Next, the processing module 10 searches the second-level unit header of the first AV file according to the dividing instruction, so that the processing module 10 can obtain the AV information corresponding to a first position code and a second position code (similar to step S02). In other words, AV information (e.g., second-level AV information) of the first position code (i.e., first designated information) and the second position code (i.e., second designated information) corresponding to the dividing instruction can be obtained in the second-level unit header of the first AV file. Next, the reading unit 21 reads the first package units corresponding to the second-level AV information of the first position code and that of the second position code (similar to steps S03 and S04).

The AV information of the second-level unit header of the first AV file is divided into a first-part AV information, a second-part AV information, and a third-part AV information according to the first position code and the second position code.

Then, the processing module 10 duplicates all of the data in the corresponding second-level unit header 40 of the first AV file to the first register region to form a second-level unit header 40 of the first register region (similar to step S08). Likewise, the processing module 10 duplicates all of the data in the corresponding second-level unit header 40 of the first AV file to the second register region to form a second-level unit header 40 of the second register region (similar to step S08). Next, the processing module 10 deletes the first-part AV information and the third-part AV information in the corresponding second-level unit header 40 of the first register region according to the first position code and the second position code (similar to step S09). And then, the processing module 10 deletes the first-part AV information and the second-part AV information in the corresponding second-level unit header 40 of the first register region according to the first position code and the second position codes (similar to step S09). Next, the processing module 10 duplicates each of the first package units 50 corresponding to the second-part AV information of the first AV file to the first register region (similar to step S10). Then, the processing module 10 combines the second-level unit header 40 with the corresponding first package units 50 in the first register region to be the second AV file (similar to step S11). Further, the processing module 10 deletes the second-part AV information and the third-part AV information corresponding to the second-level unit header 40 of the first AV file according to the first position code and the second position code (similar to step S12).

Likewise, the processing module 10 duplicates each of the first package units corresponding to the third-part AV information of the first AV file to the second register region (similar to step S10). Similarly, the processing module 10 combines the second-level unit header 40 with the corresponding first package units in the second register region to be the third AV file (similar to step S11).

Further, the processing module 10 deletes each of the first package units of the second-part AV information in the first AV file according to the position code (similar to step S12), and the processing module 10 deletes each of the first package units of the third-part AV information in the first AV file. Next, the processing module 10 deletes the second-part AV information and the third-part AV information corresponding to the second-level unit header of the first AV file according to the second position code (similar to step S13).

Accordingly, a first AV file can be divided into a first AV file corresponding to a first-part AV information, a second AV file corresponding to a second-part AV information, and a third AV file corresponding to a third-part AV information.

In this embodiment, as an example, supposed that the person detected in the event went across the frame with 0.2 seconds; that is, the camera captures that the person went across the warning region from 9:00:00.000 to 9:00:00.200, Jan. 1, 2016, and the number of the frames involving the person is seven (e.g., the 0^{th} first package unit to the 6^{th} first package unit). In this case, when the detail information of the event are unchanged, in addition to the self-defined track 513 of the 0^{th} first package unit 50, the first package units 50 from number 1 to 6 do not need to record the same information repeatedly. The use of the self-defined track 513 may be adjusted according to user requirements; for example, in areas with poor network reception, the user may configure the self-defined track 513 of each of the first package units 50 to record the detail information, so that each of the individual first package units 513 can still record the detail information of the event when some of the packs are lost during the transmission. In this embodiment, the warning state with “On” symbol may be recorded in the self-defined track 513 of the 0^{th} first package unit 50, and the warning state with “Off” symbol may be recorded in the self-defined track 513 of the 7^{th} first package unit 513 where the person totally disappears. Accordingly, the marking of the event can be simplified. Therefore, ten first package units 513 may be packaged in one second package unit 301. The second package unit 301 may have its self-defined track to record the event. Hence, the second package unit 301 can be adapted to integrate the records of the event, and the contents of the second package unit 301 can be adapted to facilitate the integration of the data in the first package units 50. In this embodiment, the self-defined track of the second package unit 301 may record the detected event as, e.g., “event of invading the warning region #1”, and the warning level is indicated as “High” as recorded in the first package unit 50. Further, the second package unit 301 may record a warning data, and the warning data records the unit ID of the beginning of the warning event, i.e., the first time the warning state becomes “On”. In other words, the warning event is firstly recorded at the 0^{th} first package unit 50. Conversely, the ending of the warning event indicates the last time the warning state becomes “On”. In this embodiment, since the warning state is changed to “Off” at the 7^{th} first package unit 50, the ending of the warning state is recorded at the 6^{th} first package unit 50. Accordingly, users can browse, search, divide, combine, or dealing with the data in a convenient manner. In this embodiment, when a user checks the second package unit 301, the user can understand that the occurring positions of the event are located at the first package units 50 from number 0 to 6. Hence, when data is recorded in such manner, not only the event data can be integrated with and packaged with the AV information, but also the event data can be stored systematically. Further, users can search the target contents in the data structure to perform recording, combining, dividing, or other procedures without additional databases. The file format may greatly increase the flexibility of the design for safety surveillance and storage system.

The electronic device may be a computer, a notebook computer, a mobile phone, a tablet computer, a smart phone, or other calculators having computation functions, but embodiments are not limited thereto.

The processing module 10 may be a microprocessor, a microcontroller, a digital signal processor, a microcomputer, a central processing unit (CPU), a field programmable gate arrays (FPGA), programmable logic devices (PLD), state machines, logic circuits, analog circuits, digital circuits, and/or any processing unit for signal processing (analog and/or digital) based on operation instructions.

The storage module 20 may include one or more storage units. The storage unit may be a read only memory (ROM), a random access memory (RAM), a volatile memory, a non-volatile memory, a static memory, a dynamic memory, a flash memory, and/or any equipment for storing digital information. In some embodiments, the storage unit may be a hard disk, a flash disk, a memory card, a solid-state hard disk, an electrically-erasable programmable non-volatile memory, or other storage devices, embodiments are not limited thereto.

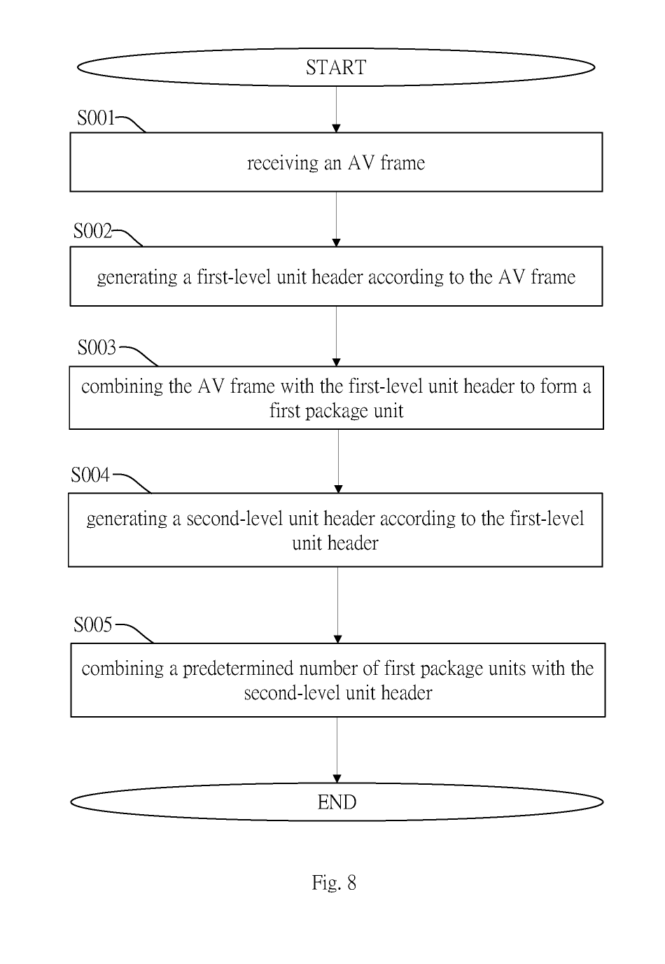

FIG. 8 illustrates a flowchart of one embodiment of an establishing method for AV file of the instant disclosure. Please refer to FIGS. 8, the processing module 10 receives several AV frames 51 (step S001), and the processing module 10 generates a first-level unit header 52 according to each of the AV frames 51 (step S002). The first-level unit header 52 has a first-level position code 521 and a first-level AV information 522 corresponding to the AV frame 51. In other words, the processing module 10 analyzes each of the AV frames 51 to obtain the first position code 521 and the first-level AV information 522 of the AV frame 51. Hence, the obtained first-level position code 521 and the first-level AV information 522 are established in the first-level unit header 52.

Then, the processing module 10 combines the first-level unit header 52 with the corresponding AV frame 51 to form a first package unit 50 (step S003). Accordingly, the first package unit 50 comprises the first-level unit header 52 and the AV frame 51, and the first-level unit header 52 has a first position code 521 and a first-level AV information 522 corresponding to the AV frame 51.

In some embodiments, the AV frame 51 comprises an image track 511 and a sound track 512. The image track 511 and the sound track 512 may be recorded in the first package unit 50, individually.

In some embodiments, each of the AV frames 51 may have tags corresponding to event data and/or self-defined data. In one embodiment of step S002, in the case that the AV frame 51 has the corresponding tag, the processing module 10 generates the first-level unit header 52 according to the AV frame 51 and the corresponding tag. In one embodiment of step S003, the processing module 10 combines the first-level unit header 52, the corresponding AV frame 51, and the corresponding tag with each other to form the first package unit 50. In some embodiments, the processing module 10 may establish a self-defined track 513 according to the tag. Further, the image track 511 and the sound track 512 of the AV frame 51 as well as the self-defined track 513 corresponding to the AV frame 51 may be recorded in the first package unit 50, individually.

In this embodiment, the processing module 10 can generate several first package units 50 by executing the steps S001 to S003 repeatedly. In other words, the processing module 10 records each of the AV frames 51 as one first package unit 50 according to the predefined manner.

Next, the processing module 10 further packages a predefined number of first package units 50 as one or more second package units 301.

In the procedure for generating each of the second package units 301, the processing module 10 generates a second-level unit header 40 according to the AV information in the first-level unit headers 52 of the first package units 50 to be packaged. In other words, the second-level unit header 40 has the first-level position codes 521 and the first-level AV information 522 corresponding to the AV frames 51 and a second-level AV information. The AV information owned by the second-level unit header 40 may be all of, extracts of, or sum of the first-level AV information 522. Then, the processing module 10 combines the predefined number of first package units 50 with the second-level unit header 40 to form the second package unit 301 (step S005). When the processing module 10 only generates one second package unit 301 or generate a number of second package units 301 in which the number is less than the predefined number based on all of the received AV frames 51, the second package unit(s) 301 is the AV file itself

In some embodiments, the processing module 10 may check the number of the generated first package units 50 according to a predefined number during the generation of the first package units 50 or after the generation of the first package units 50. When the processing module 10 determines the number of the first package units 50 achieves the predefined number, the processing module 10 consecutively packages first package units 50 in the predefined number to be one second package unit 301, then the processing module 10 packages other first package units 50 in the predefined number to be another second package unit 301, and so forth. In the end, when the processing module 10 determines that the number of the rest first package units 50 does not achieve the predefined number, the processing module 10 still packages the rest first package units 50 to be a last second package unit 301. Finally, the processing module 10 combines the second package units 301 with each other to be the AV file.

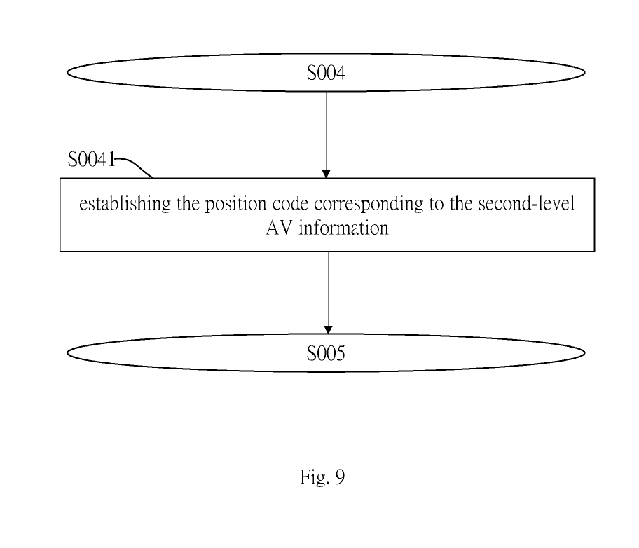

FIG. 9 illustrates another flowchart of one embodiment of the establishing method for AV file. Please refer to FIG. 9, in one embodiment, the processing module 10 may establish the position code corresponding to each of the first package units 50 in each of the second-level AV information of the second-level unit header 40 (step S0041). In other words, when the processing module 10 generates the second-level unit header 40 according to the step S004, the processing module 10 further establishes the position code corresponding to the second-level AV information in each of the second-level unit header 40. The encoding of the position code may be configured according to practical situations, but embodiments are not limited thereto.

Please refer to FIG. 8. The processing module 10 selects the first package units 50 in order and determines if the number of the selected first package units 50 achieves the predefined number. If the number of the selected first package units 50 achieves the predefined number, the processing module 10 would use the first-level unit headers 52 of the selected first package units 50 to generate the second-level unit header 40, and the processing module 10 combines the selected first package units 50 with the corresponding second-level unit header 40 to form the second package unit 301. If the number of the selected first package units 50 does not achieve the predefined number, the processing module 10 would further select more first package units 50 until the number of the selected first package units 50 achieves the predefined number. If the number of the selected first package units 50 does not achieve the predefined number and the processing module 10 determines that there is no rest first package units 50, the processing module 10 combines the first package units 50 in a number less than the predefined number and the corresponding second-level unit header 40 with each other to form the second package unit 301.

In some embodiments, the processing module 10 may set the first package units 50 in the predefined number as a group before checking rest first package units 50. Then, when the processing module 10 further selects the predefined number of first package units 50 from the rest first package units 50, the processing module 10 sets the first package units 50 in the predefined number as another group, and so forth, until all of the first package units 50 are grouped. Lastly, the processing module 10 combines each of the groups of the first package units 50 with the corresponding second-level unit header 40 with each other to form the second package unit 301. Accordingly, the AV file can be obtained.

In this embodiment, the processing module 10 obtains a basic package unit according to each of the AV frames 51. Then, the processing module 10 packages the first package units 50 in the predefined number as the second package unit 301. Accordingly, an AV file with hierarchical structure can be generated.

When the size of the AV file is larger (i.e., when the AV file has a great number of AV frames 51), the processing module 10 may further package the second package units 301 in a predefined number to be an upper-level package unit.

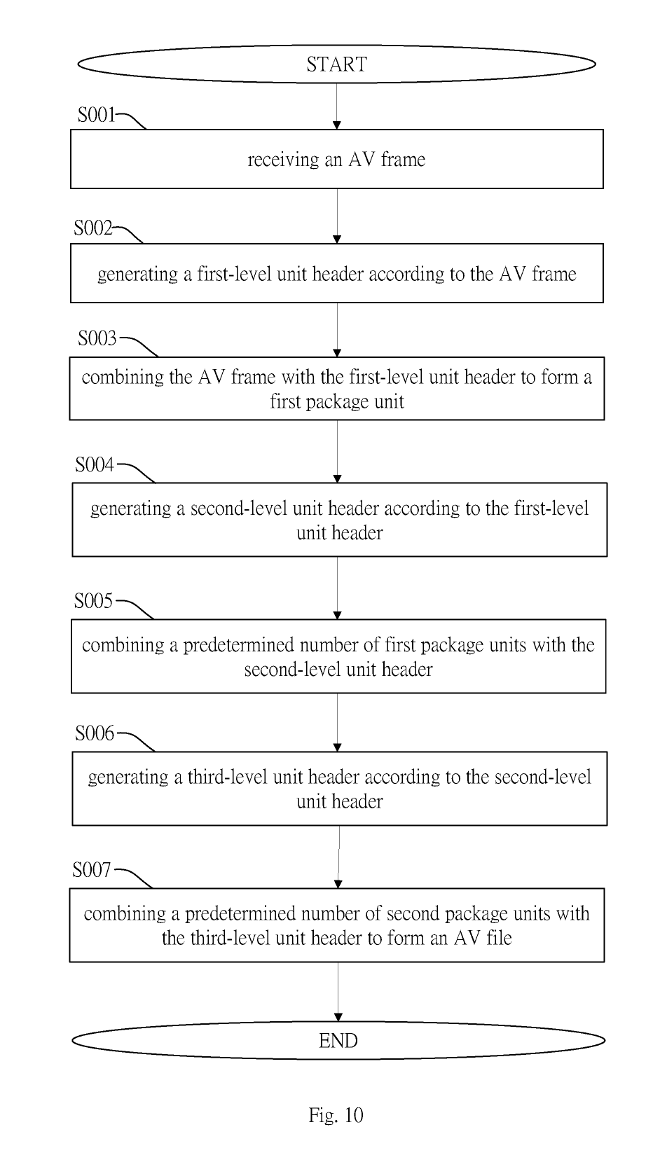

FIG. 10 illustrates a flowchart of another embodiment of the establishing method for AV file. Please refer to FIG. 10. The processing module 10 generates several second package units 301 by executing the steps S004 to S005 repeatedly. The processing module 10 may check the number of the generated second package units 301 according to a predefined number during the generation of the second package units 301 or after the generation of the second package units 301. Next, when the processing module 10 determines the number of the second package units 301 achieves the predefined number, the processing module 10 generates a third-level unit header according to the second-level unit headers 40 of the second package units 301 (step S006). Next, the processing module 10 combines the predefined number of second package units 301 with the third-level unit header to form a third package unit (step S007). Further, the processing module 10 may generate several third package units by executing the steps S006 to S007 repeatedly. When the processing module 10 determines that the number of the rest second package units 301 does not achieve the predefined number, the processing module 10 still packages the rest second package units 301 to be a last third package unit.

In other words, when the size of the AV file is larger (i.e., when the AV file has a great number of AV frames 51) and the number of the package units is greater than the predefined number, the processing module 10 would have to package the package units as a higher level package unit. For example, the processing module 10 may package several first package units 50 as a second package unit 301, package several second package units 301 as a third package unit, package several third package units as a fourth package unit, and so forth. That is, the processing module 10 may generate an upper-level unit header (e.g., a second-level unit header 40 or a third-level unit header) according to the lower-level unit headers (e.g., first-level unit headers 52 or second-level unit headers 40) of the to-be-packaged lower-level package units (e.g., the first package units 50 or the second package units 301). Then, the processing module 10 combines the to-be-packaged lower-level package units (e.g., the first-level unit headers 52 or the second-level unit headers 40) with the upper-level unit header (e.g., a second-level unit header 40 or a third-level unit header) to form an upper-level package unit. Accordingly, an AV file with hierarchical structure can be generated.

Accordingly, based on the number of the AV frames 51, the AV file may be formed by a second-level unit header 40 as well as one or more first package units 50, or may be formed by a third-level unit header 31 as well as one or more second package units 301, or may be formed by a Nth-level unit header as well as one or more N−1th-level package units. In other words, in the embodiments of the instant disclosure, the number of the hierarchical structure is not limited (N is a positive integer being greater than 1), and the scale of the AV file with such hierarchical structure can be expanded according to the same establishing method.

As above, since the AV information stored by the unit header with different levels in the AV file can record the position of each of the AV frames 51, by searching the second-level AV information 41 according to the searching instruction, the combining instruction, or the dividing instruction, the corresponding first package units 50 can be found in a quick manner. Hence, the processing of the AV file becomes more efficient.

What is claimed is:

1. A processing method for AV file, comprising:
receiving an operation instruction corresponding to a first AV file, wherein the first AV file comprise a plurality of first package units and a second-level unit header, each of the first package units comprises an AV frame and a first-level unit header, the first-level unit header has a first-level AV information and a first-level position code of the first package unit, and the first-level AV information and the first-level position code of the first package unit are generated according to the AV frame, the second-level unit header comprises a second-level position code and a plurality of second-level AV information respectively corresponding to the first package units, each of the second-level AV information records at least one part of the first-level AV information of the corresponding first package unit and the first-level position code of the corresponding first package unit, the operation instruction comprises at least one designated information;
searching a second-level AV information corresponding to the at least one designated information from the plurality of second-level AV information in the second-level unit header according to the operation instruction, wherein the first-level position code in the searched second-level AV information is regarded as a designated position code; and
reading, by a reading unit, the first package unit whose first-level position code corresponds to the designated position code according to the designated position code.

2. The processing method for AV file according to claim 1, further comprising:
duplicating the read first package unit to a second AV file after the reading step of the first package unit, wherein the first AV file and the second AV file have a same file format; and
updating the second-level AV information corresponding to the duplicated first package unit in the first AV file to a second-level unit header of the second AV file.

3. The processing method for AV file according to claim 2, wherein in the first AV file, the second-level unit header and the first package units are collected to be a second package unit.

4. The processing method for AV file according to claim 2, further comprising:
updating the first-level position code of the duplicated first package unit in the second AV file.

5. The processing method for AV file according to claim 4, wherein in the first AV file, the second-level unit header and the first package units are collected to be a second package unit.

6. The processing method for AV file according to claim 1, wherein the plurality of second-level AV information is divided into a first-part AV information and a second-part AV information according to the at least one designated information, wherein the processing method for AV file further comprises:
defining a register region in a storage module according to the operation instruction;
duplicating the second-level unit header of the first AV file to the register region to form a second-level unit header of the register region;
deleting the first-part AV information in the second-level unit header of the register region;
duplicating each of the first package units corresponding to the second-part AV information to the register region;
combining the second-level unit header in the register region with each of the first package units in the register region to form a second AV file;
deleting each of the first package units corresponding to the second-part AV information in the first AV file after the duplicating step of each of the first package units corresponding to the second-part AV information; and
deleting the second-part AV information in the second-level unit header of the first AV file after the duplicating step of the second-level unit header.

7. The processing method for AV file according to claim 6, wherein in the first AV file, the second-level unit header and the first package units are collected to be a second package unit.

8. The processing method for AV file according to claim 1, wherein the second-level AV information is divided into a first-part AV information, a second-part AV information, and a third-part AV information according to a first designated information and a second designated information, the processing method for AV file further comprises:
instructing a storage module to establish a first register region and a second register region;
duplicating the second-level unit header of the first AV file to the first register region to form a second-level unit header of the first register region;;
duplicating the second-level unit header of the first AV file to the second register region to form a second-level unit header of the second register region;
deleting the first-part AV information and the third-part AV information in the second-level unit header of the first register region;
deleting the first-part AV information and the second-part AV information in the second-level unit header of the second register region;
duplicating the first package units corresponding to the third-part AV information in the first AV file to the second register region to form a plurality of first package units of the second register region;
combining the second-level unit header in the second register region and the first package units in the second register region to form a third AV file;
deleting each of the first package units corresponding to the third-part AV information in the first AV file;
duplicating the first package units corresponding to the second-part AV information in the first AV file to the first register region to form a plurality of first package units of the first register region;
combining the second-level unit header in the first register region and the first package units in the first register region to form a second AV file;
deleting each of the first package units corresponding to the second-part AV information in the first AV file; and
deleting the second-part AV information and the third-part AV information in the second-level unit header of the first AV file according to the designated information.

9. The processing method for AV file according to claim 8, wherein in the first AV file, the second-level unit header and the first package units are collected to be a second package unit.

10. The processing method for AV file according to claim 1, wherein in the first AV file, the second-level unit header and the first package units are collected to be a second package unit.

11. The processing method for AV file according to claim 10, wherein in the first AV file, several second package units and a third-level unit header are packaged as a third package unit, and the third-level unit header stores the plurality of second-level AV information, the second-level position codes, and the corresponding first-level position codes in the second-level unit header related to the second package units.

12. The processing method for AV file according to claim 1, wherein in the first AV file is an AV fragment or a complete AV.

13. The processing method for AV file according to claim 1, wherein each of the AV frames comprises one of an image track, a sound track, and a combination thereof.

14. The processing method for AV file according to claim 13, wherein each of the first package units further comprises a self-defined track, the self-defined track stores a self-defined data, an event data, or a combination thereof.

15. The processing method for AV file according to claim 14, wherein the self-defined track records image data or sound data in a binary structure and a plain text form.

16. An establishing method for AV file, comprising:
receiving at least one AV frame;
recording the at least one AV frame as at least one first package unit, respectively, wherein the recording step of each of the first package units comprises:
generating a first-level unit header according to the at least one AV frame, wherein the first-level unit header stores a first-level AV information and a first-level position code of the at least one first package unit which correspond to the at least one AV frame; and
combining the at least one AV frame and the first-level unit header to be the first package unit; and
packaging the at least one first package unit as at least one second package unit according to each of the first-level position codes, wherein each of the at least one second-level package units comprises a second-level unit header and a predefined number of the first package units, and the second-level unit header records the first-level AV information and the first-level position code of each of the corresponding first package units and a second-level position code.

17. The establishing method for AV file according to claim 16, wherein the packaging step of each of the second package units comprises:
generating the second-level unit header according to each of the first-level unit headers of the predefined number of the first package units; and
packaging the predefined number of the first package units and the second-level unit header.

18. The establishing method for AV file according to claim 16, further comprising:
packaging the at least one second package unit as at least one third packaging unit consecutively, wherein each of the at least one third package units comprises a third-level unit header and a predefined number of the second package units, and the third-level unit header records the second-level AV information and the second-level position code of each of the corresponding second package units and a third-level position code corresponding to the at least one third package unit.

19. The establishing method for AV file according to claim 16, wherein the second-level position code corresponds to the at least one second package unit.
